(19) United States
(12) Patent Application Publication
(10) Pub. No.: US 2016/0140663 A1
(43) Pub. Date: May 19, 2016

(54) SYSTEM AND METHOD FOR PROVIDING SELECTABLE TEMPOROSPATIAL INSURANCE COVERAGE

(71) Applicants: Evgeny Greenberg, Netanya (IL); Dmitry Geyzersky, Netanya (IL); Vladimir Hazan, Haifa (IL); Ronen Abargel, Ramat Hasharon (IL)

(72) Inventors: Evgeny Greenberg, Netanya (IL); Dmitry Geyzersky, Netanya (IL); Vladimir Hazan, Haifa (IL); Ronen Abargel, Ramat Hasharon (IL)

(73) Assignee: CLICK-INS LTD., Netanya (IL)

(21) Appl. No.: 14/943,146

(22) Filed: Nov. 17, 2015

Related U.S. Application Data
(60) Provisional application No. 62/080,460, filed on Nov. 17, 2014.

(51) Int. Cl. G06Q 40/08

(52) U.S. Cl. CPC G06Q 40/08

(57) ABSTRACT

The disclosure is directed to systems and methods for providing selectable, temporospatial-specific insurance coverage. More specifically, the disclosure is directed to ad-hoc insurance coverage methods for individuals, businesses, vehicles and the like that is coverage-event driven rather than coverage-time driven, and the physical systems to facilitate the event-driven coverage.

### BACKGROUND

The present disclosure relates to systems and methods for providing location and time based insurance coverage. Specifically, the disclosure relates to systems and methods for providing selectable, temporospatial-specific insurance coverage.

Conventional methods for pricing and selling vehicle insurance are generally based upon time periods (e.g., months or years), also known as terms. An applicant's data, such as age, sex, location of residence, and driving record are combined with other factors to create an actuarial class, which is then used to arrive at a price. This price is then associated with a unit of exposure. In conventional insurance, the unit of exposure is a period of time (a term). As the insurance contract is then principally defined based upon the exposure unit, conventional insurance contracts are principally defined by the term. However, such conventional insurance mixes a fixed cost with a variable usage pattern. Among other disadvantages, this approach penalizes low mileage customers.

Moreover, vehicle and residential insurance coverage required the insured to obtain insurance a bundle of first party (the insured) and third party (everyone else) coverage that are acquired regardless of their need at any given time. For example, in vehicle coverage, an insured person is still assessed third party property and bodily damage, even while the vehicle is parked. Likewise, in residential insurance, the insured is required to obtain, for example, flood insurance year-round even when the probability for a flood is negligible.

Accordingly, what is needed is an improved system and method for addressing such issues.

These and other aspects are addressed by the following systems and methods for providing selectable, temporospatial-specific insurance coverage.

### SUMMARY

Disclosed, in various embodiments, are systems system and methods for providing selectable, temporospatial-specific insurance coverage.

In an embodiment, provided herein is a method of providing customized vehicle temporospatial coverage policy to an individual, comprising: contacting an insurance provider; electing insurance coverage selected from first party insurance, third party insurance, or a combination thereof, wherein the insurance coverage comprises: collision, bodily injury, property damage, or a combination comprising one or more of the foregoing; the insurance provider, based on the individual's predetermined rate factor, issuing a temporospatial insurance coverage policy; and the insurance provider, delivering the insurance coverage policy to the individual.

In another embodiment, provided herein is a system for generating customized vehicle temporospatial coverage policy, comprising: an insurance provider server; an application server; an input device within a communication device adapted to contact the insurance provider's server, the application server or both; a processor coupled to the input device that executes instructions contained in memory for electing insurance coverage selected from first party insurance, third party insurance, or a combination thereof, wherein the insurance coverage comprises: collision, bodily injury, property damage, or a combination comprising one or more of the foregoing; an output device configured to generate, based on an individual's predetermined rate factor, a temporospatial insurance coverage policy; and a vehicle wherein the temporospatial insurance coverage policy is for a predetermined minimum period.

In yet another embodiment, provided herein is a method of providing customized residence temporospatial coverage policy to an individual, comprising: contacting an insurance provider; electing insurance coverage selected from first party insurance, third party insurance, or a combination thereof, wherein the insurance coverage comprises: theft, bodily injury, property damage, flood insurance, or a combination comprising one or more of the foregoing; the insurance provider, based on the individual's predetermined rate factor, issuing a temporospatial insurance coverage policy; and the insurance provider, delivering the insurance coverage policy to the individual.

In an embodiment, provided herein is a system for providing customized residence temporospatial coverage policy to an individual, comprising: an insurance provider server; an application server; an input device within a communication device adapted to contact the insurance provider's server, the application server or both; a processor coupled to the input device that executes instructions contained in a non-volatile memory for electing insurance coverage selected from first party insurance, third party insurance, or a combination thereof, wherein the insurance coverage comprises: theft, bodily injury, property damage, flood insurance, or a combination comprising one or more of the foregoing; an output device configured to generate, based on an individual's predetermined rate factor, a temporospatial residence insurance coverage policy; and a residence wherein the temporospatial insurance coverage policy is for a predetermined minimum period to all coverage other than property damage provided on a permanent basis when the residence is purchased with burrowed funds, and is configured to be the amount borrowed.

These and other features of the systems and methods for providing selectable, temporospatial-specific insurance coverage will become apparent from the following detailed description when read in conjunction with the drawings, which are exemplary, not limiting.

### BRIEF DESCRIPTION OF THE FIGURES

For a better understanding of the systems and methods for providing selectable, temporospatial-specific insurance coverage, with regard to the embodiments thereof, reference is made to the accompanying drawings, in which:

FIG. 1, is a schematic illustrating an embodiment of the system's components and their interrelations;

FIG. 2, is a schematic representing an embodiment of the system's architecture;

FIG. 3, is a flow chart illustrating an embodiment of policy purchase sequence;

FIG. 4, illustrates an embodiment of the system's algorithm layer schematic;

FIG. 5, illustrates operations performed by the application server to facilitate the methods described;

FIG. 6 Illustrates an embodiment of obtaining temporosptial insurance at a given destination for a vehicle; and

FIG. 7, illustrates the gateway for the system's interactions with insurance providers.

### DESCRIPTION

Provided herein are embodiments of systems and methods for providing selectable, temporospatial-specific insurance coverage.

The systems and methods described herein can provide a temporary, selective insurance policy to a user based on the user's need. Typically, methods for determining costs of motor vehicle insurance involve gathering relevant historical data from a personal interview with, or a written application completed by, the applicant for the insurance and by referencing the applicant's public motor vehicle driving record that is maintained by a governmental agency, such as a Bureau of Motor Vehicles. Such data results in a classification of the applicant to a broad actuarial class for which insurance rates are assigned based upon the empirical experience of the insurer. Many factors are deemed relevant to such classification in a particular actuarial class or risk level, such as age, sex, marital status, location of residence and driving record. Further, current system of insurance creates groupings of vehicles and drivers (actuarial classes) based on classifications, for example: Vehicle: Age; manufacturer, model; and value; Driver: Age; sex; marital status; driving record (based on government reports), violations (citations); at fault accidents; and place of residence.

The classifications, such as age, are further broken into actuarial classes, such as 21 to 24, to develop a unique vehicle insurance cost based on the specific combination of attributes for a particular risk.

A change to any of this information might result in a different premium being charged, if the change resulted in a different actuarial class or risk level for that variable. For instance, a change in the drivers' age from 38 to 39 may not result in a different actuarial class, because 38 and 39 year old people may be in the same actuarial class. However, a change in driver age from 38 to 45 may result in a different premium because the records of the insurer indicate a difference in risk associated with those ages and, therefore, the age difference results in a change in actuarial class or assigned risk level.

Typical Coverage provided for a given term, that in certain circumstances may be obtained using the systems and methods described herein, may include: Types of losses covered, liability (1^{s} and 3^{rd} parties), uninsured or underinsured motorist (3^{rd} Party), comprehensive (1^{st} party), and collision; liability limits; and deductibles.

Likewise, homeowners insurance coverage can typically be used to cover property and belongings; self-protection (1^{st} party), in other words, having enough liability coverage to protect oneself from lawsuits resulting from negligence or events that could occur on your property; lender requirements coverage (or where the lender will require to cover the house for at least the amount of the mortgage or the replacement cost of the dwelling).

Types of coverage selectively obtained (and consequently cancelled) using the methods and systems described herein, may be one or more of the following:
a. Damage: Covers damage to the house. The face amount of the policy (for example $100,000) is the most any 1^{st} Party may receive if the house is totally destroyed;
b. Other Structures: Covers damage to other structures or buildings, such as a detached garage, work shed, or fencing:
c. Personal Property: Covers damage to, or loss of personal property. Personal property can include household contents and other personal belongings used, owned or worn by a 1^{st} Party and their family;
d. Additional Living Expenses: Covers additional living expenses when incurred. This means that the policy covers the necessary living expenses up to the stated limit, incurred by the insured to continue, as nearly as possible, the normal standard of living when the house cannot be occupied due to a covered loss;
e. Comprehensive Personal Liability: Covers personal liability, in other words, protecting a 1^{st} Party against claims arising from accidents to 3^{rd} parties on property owned or rented by the 1^{st} Party. With a few exceptions, such as auto or boating accidents, it is an all-purpose liability policy that follows the 1^{st} party wherever they go;
f. Medical Expenses: Coverage is limited to an amount per person and per accident for injuries occurring on premises of the 1^{st} Party to 3^{rd} Parties, or elsewhere, if caused by the 1^{st} Party, a member of their family, or their pets. An important feature of this coverage is that payment is made regardless of legal liability; and
g. Flood Insurance: covers damage to property and persons, 1^{st} and 3^{rd} parties in case of flood;

The list provided are for illustrative purpose only and should not be limiting. Accordingly and in an embodiment, provided herein is a method of providing customized vehicle temporospatial coverage policy to an individual, comprising: contacting an insurance provider; electing insurance coverage selected from first party insurance coverage, third party insurance coverage, or a combination thereof, wherein the insurance coverage comprises: collision, bodily injury, property damage, or a combination comprising one or more of the foregoing; the insurance provider, based on the individual's predetermined rate factor, issuing a temporospatial insurance coverage policy; and the insurance provider, delivering the insurance coverage policy to the individual. The coverage can be obtained by the individual, using an input device, such as a smartphone, using a communication network or through wide area wireless network contacting a management server in contact with an insurance provider. Based on needs and location, the vehicle owner can elect the types of coverage needed for a specific trip, for example, collision for a 3^{rd} party driver borrowing the vehicle. Using interstitial communication, the insured may engage in a dialogue with the management server and provide some or all the details described hereinabove. These details can be, for example, location of the vehicle, the starting and end points of the trip, route details and the like. In addition or alternatively, the information can be the state of the vehicle, for example, pictures of the vehicle including dents and other preexisting damage. The data transmitted can be tagged with metadata, thus providing a time stamp for any given issued policy, as well as removing some of the risk for insurance fraud.

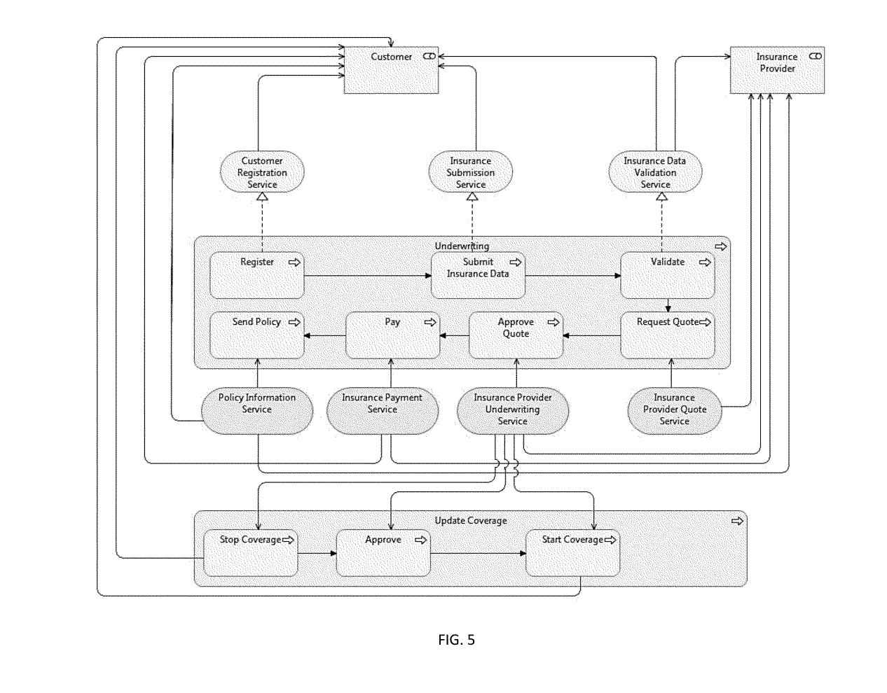

Some of the operations performed by the application server to facilitate the methods described herein, are illustrated in FIG. 5.

Further, location data can be gathered in real-time using Geo-positioning systems located on the input device, or for each of the input devices may be any type of mobile electronic device having a display and wireless communication capability. These are, for example, cellular telephone handsets, personal digital assistants (PDAs), tablet computers, phablets and handheld gaming devices and the like. The location determination can be, for example when the vehicle can be within a range of between about 1 m to about 500 m from a location determining device, for example, a short range communication device. Short-range communications are for example, Bluetooth®. (“BLUETOOTH® is a registered trademark of Bluetooth SIG”), WiFi® (“WI-FI® is a registered trademark of the Wi-fi alliance”), UWB, Zigbee® (“Zigbee® is a registered trademark of Zigbee alliance), whispering optical display, 3G and 4G other augmented sensor networks etc. The display devices can communicate with the main application server and each other through predetermined communications channels.

Upon receiving authentication of the user, the insurance provider can use the above-identified factors (e.g., car type, make and model, age and sex of the driver etc.) to determine a daily rate for each type of coverage sought by the particular user under the circumstances inputted to the system. The coverage policy can therefore have limited duration of a predetermined minimum period. It should be understood, that the daily term is NOT for a bundle, but for a specific type of coverage, for example, 3^{rd} party bodily damage, 1^{st} party bodily damage, property damage and the like, each being provided with a daily rate.

For example, the individual's predetermined rate factor used in the methods and systems for providing customized vehicle temporospatial coverage policy to an individual can comprise; expected trip mileage or kilometerage, trip location, trip beginning point, trip end point, driver's age, driver's record, driver's identity, driver's gender, or a combination comprising one or more of the foregoing. As noted, at the end of the trip, the user can communicate with the management server and cancel any and all type of insurance that is not required at any point by a government authority.

The step of delivering the insurance coverage used in the methods and systems for providing customized temporospatial coverage policy to an individual can comprise in an embodiment; the insurance provider generating a recovery key identifiable by a unique token identifier; generating a passcode associated with the user; providing the passcode and the recovery key to the user; using the recovery key to obtain the user identifier and the one or more encryption keys; creating an inactive token by storing the user identifier on a blank token; and activating the inactive token to enable the individual to activate the policy, the activation being based on information received from the input device during the interstitial communication stage from the recovery key and the passcode received from the user. The token can therefore be temporary and expire at the end of the term automatically (i.e. without human intervention).

The vehicles covered using the methods and systems for providing customized vehicle temporospatial coverage policy to an individual can be, for example, a marine vehicle, terrestrial vehicle, air vehicle, or a combination thereof.

As indicated, the methods and systems for providing customized vehicle temporospatial coverage policy to an individual can further comprise arriving at a terminal location; and the individual selectively cancelling, for example, the first party insurance, third party insurance, or a combination thereof, wherein the insurance coverage comprises: collision, bodily injury, property damage, or a combination comprising one or more of the foregoing. Regardless of cancelling the maximum term per coverage sought is not intended to exceed 24 hours. Generally, change in the temporospatial environment of the vehicle can be used to alter the coverage package (bundle of coverage types) purchased or maintained.

In an embodiment, the methods described herein are implemented in the systems described herein. Accordingly and in another embodiment, provided herein is a system for generating customized vehicle, temporospatial coverage policy, comprising: an insurance provider server; an application server; an input device within a communication device adapted to contact the insurance provider's server, the application server or both; a processor coupled to the input device that executes instructions contained in memory for electing insurance coverage selected from first party insurance, third party insurance, or a combination thereof, wherein the insurance coverage comprises: collision, bodily injury, property damage, or a combination comprising one or more of the foregoing; an output device configured to generate, based on an individual's predetermined rate factor, a temporospatial insurance coverage policy; and a vehicle wherein the temporospatial insurance coverage policy is for a predetermined minimum period.

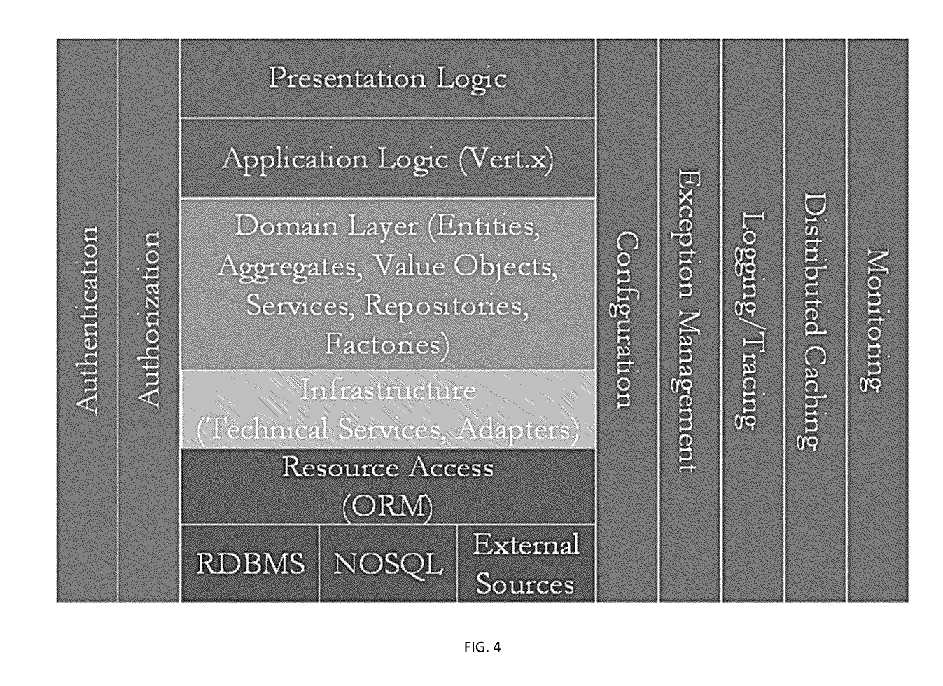

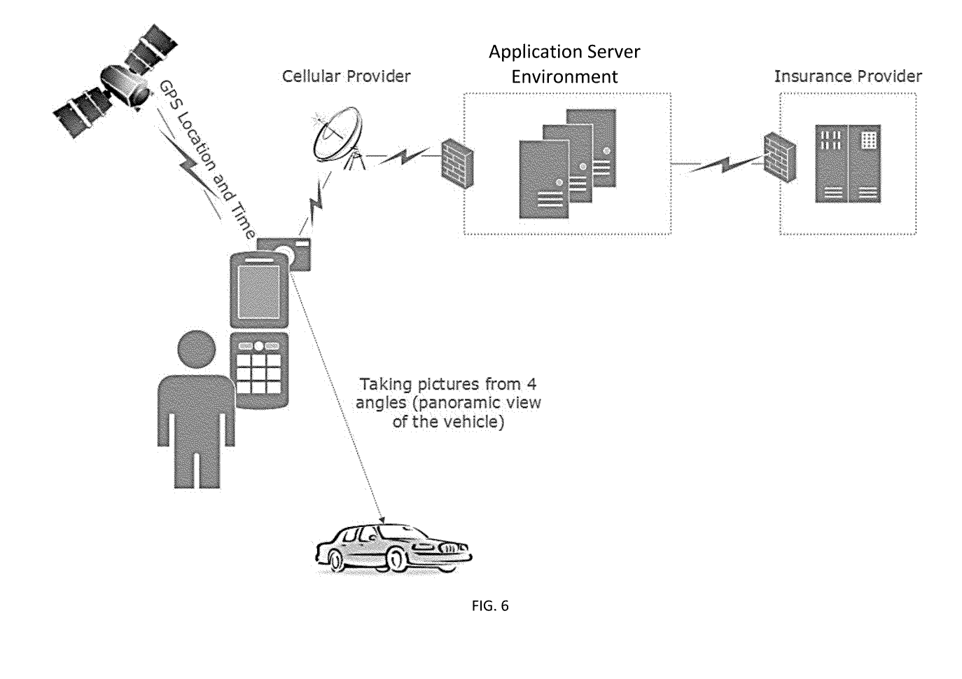

The systems and methods for generating customized vehicle, residential, renter, business or other temporospatial coverage policy can be adapted to: establish a dedicated communication network, (or use existing networks) robust enough to endure a large number of dislocated devices (e.g., cellular telephone handsets or smartphones, personal digital assistants (PDAs), tablet computers, phablets, laptops, handheld gaming devices and the like) without overloading the network. The systems can also be adapted and configured for generating communication algorithm to send data packets (e.g., proof of policy, token to activate various actuators in the vehicles) to the (input) devices in a fast and efficient manner (see e.g., FIGS. 4, 6). Also, the systems provided herein, used in conjunction with the methods described herein, can be configured to create a positioning system that will temporospatially pinpoint the dislocated input devices and/or vehicle(s) (see e.g., FIG. 6).

The communication network channel can be the conduit where all the information can be transmitted from an application server(s) to the input devices. Typical open communication network grid in a large event or public area can often be quite congested. For example, using a dedicated protocol of communication to avoid data overload can effectively and efficiently manage the delivery of policy to the user.

In an embodiment, using a mapping application residing on the input device, end users located in the vicinity of a location determining device can log on to the management server and synchronize with the system. The term “synchronized” refer for example, to the transfer of timing information and files or content so that input devices (and/or vehicles) are “synchronized” with respect to the information on the application server.

For example, global positioning (or geopositioning) system (GPS) refers to a space-based global navigation satellite system that can provide location and time (temporospatial) information at practically all times and for practically anywhere on the Earth when and where there is an unobstructed line of sight to four or more GPS satellites. Typically, a GPS receiver used in the systems and methods provided as part of the mobile input device herein can calculate a position of the receiver by precisely timing the signals sent by the GPS satellites. Each satellite can then continually transmit messages that include such information as the time the message was transmitted, the precise orbital information for the satellite, and the general system health and rough orbits of all GPS satellites. The GPS receiver located for example on the application server, can then utilize the messages it receives to determine a transit time of each message independent of the end user and compute the distance to each satellite. These distances along with the satellites' locations are used to compute the position of the receiver and transmitter.

Additionally, communication between the application server and the insurance provider server can be secured wired or wireless communication. The secured communication of the data transferred between the application server and the provider's server can utilize cryptography keys to encrypt and decrypt secured data. The keys can be established within the secured communications session. Alternatively, the application server and insurance provider's server can form a group of processor-based nodes (e.g., servers and/or other resources) that act like a single system. In other words, the clustering can communicatively connect two or more computers together in such a way that they behave like a single computer. Clustering can be used for parallel processing, load balancing, and/or fault tolerance (or “high availability”), as examples. Each node of a cluster may be referred to as a “member” of that cluster.

The terms “user”, “customer”, “consumer” and formatives thereof as utilized herein refer to any party desiring to initiate interaction with an information/support service accessible by the methods and systems described herein.

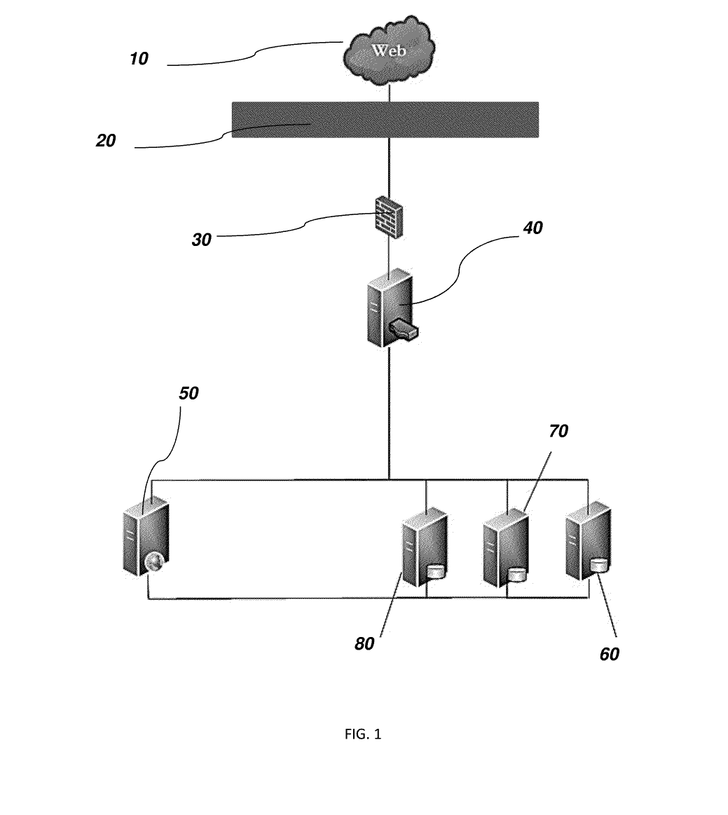

Additionally, a local area network (LAN) may also be incorporated into the system. The local area network may be in communication with the main application server(s) and the insurance provider's server (see e.g., FIG. 1). The local area network may be a wireless local area network.

In an embodiment, the input device can include a controller comprising a central processing unit (CPU) that is microprocessor-based. The controller can perform various functions including, for example, contacting the insurance provider's server, the application server or both and communicating to the insurance provider the location of the vehicle, or a state of the vehicle, or both. The user interface used in the systems and methods described herein to facilitate the communication, may be one or a combination of different types of user interfaces depending upon the device. Many tablet computers include push-buttons or touch screens or both. Keyboards, styluses and other types of input devices. The user interface can be used to provide various inputs and responses to elements displayed on the input device. When the user interface is a touch screen or touch display, the screen display and the user interface may be one in the same. More than one user interface may be incorporated into the input device.

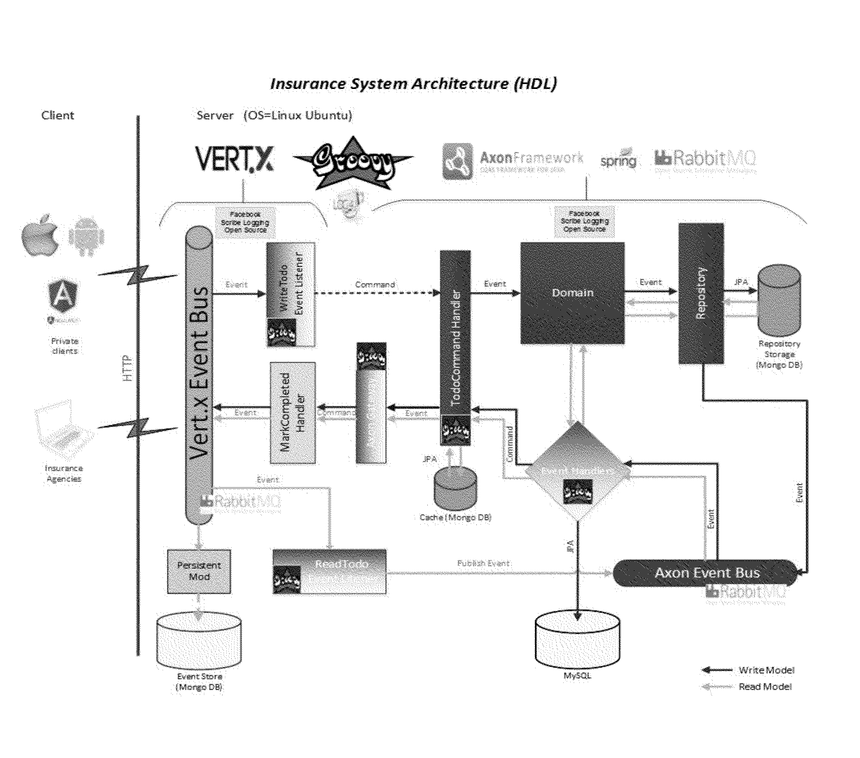

A memory component can also be in communication with the controller. The memory component may include different types of memory that store different types of data. The memory component may store operating software for the device, operating data, user settings, documents, and applications. The applications may perform various functions, including an application for communicating with the main application server and location determinators illustrated in FIG. 2 and obtaining data from the insurance provider module and the application server. The application may allow the input device(s) to communicate directly with the application server.

A web interface may be used for communicating with the application server and/or the insurance provider's module. The web interface may allow a connection to the local area network (e.g., LAN or WiLAN). The web interface may allow communication through a wireless network such as a local area network, wide area network (WAN) or a dedicated mobile or cellular network.

An interface component of the portal (in other words, the home page of the web interface) accessed when using the systems and methods described, can be configured to connect to and retrieve requested data from a gateway application server (in other words, the database main server) See e.g., FIGS. 1, 2 and 4.

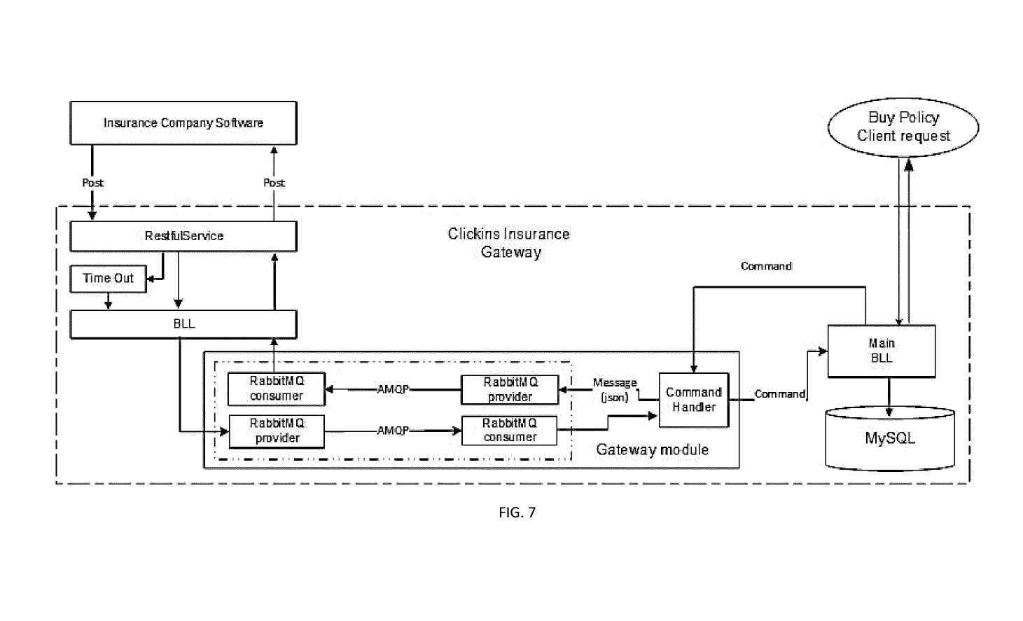

The term “application server” or “gateway server” refers to a back-end hardware and software product that is used to manage content. Further, the term “dedicated interface” refers to information or content items displayed within a region of a portal web site or a specific application used for a specific event. For example, a dedicated interface can be a component of a portal web site and is a smaller web application that runs on a portal server (e.g., a portlet). The interaction of the application or gateway server with insurance provider is illustrated for example in FIG. 7.

End-user dedicated and/or customized interfaces can be applications that provide the proper queries to access relevant data, provide access for uploading product or service data, upon obtaining permission in the form of, for example, a code or a token, accessing other user-specific data server(s), e.g., the application server and the like. (see e.g., FIG. 1)

A load balancer (see FIG. 1, element 20) can be used in the systems implementing the methods described herein and be coupled to a network node that may include a processor or a computer 40 coupled to the dedicated network and that communicates with other processors on the network including clients and servers (50-80). A load balancer may be a separate node or may be incorporated into another node such as, for example, the main application server (see e.g., FIG. 2). A node refers to any device coupled to the network including clients, caches (see e.g., FIGS. 1-70), proxies 40, location determining sensors and servers 80. A “data center” refers to a group of at least two servers (e.g., main application servers FIG. 1, 60, 70) and insurance provider module's server) and may include a load balancer.

The methods described herein can be achieved through processing whereby a browser can send a Hypertext Transfer Protocol (“HTTP”) request to a portal engine. (Portal implementations may be structured with functionally distinct modules referred to generally as an engine and a dedicated interface container, where the engine is responsible for content and the container is responsible for dedicated interface lifecycle functions that include dispatch of the action and render methods. The term “portal engine”, however, is used as a reference to a combination of these two functional modules.).

In addition, routines such as allowing access to the various database(s), or among user (e.g., trip)-specific data servers can be restricted to back-end (main) application server and systems.

Likewise, the step of temporospatially locating each of a plurality of the input device(s) and/or the vehicles within a discrete area (in other words, beginning point or end point of the trip) can comprise the step of triangulating each device or vehicle using WiFi, Bluetooth, GPS, 3G, 4G, ZigBee, Near-Field Communication or a combination comprising the aforementioned platforms.

The term “triangulating” is used here-at in a loose sense for lack of better terminology. It does not necessarily have to imply collecting data from three linear vectors pointing into a hierarchical space and to a subregion or node located at an intersection point of the three linear vectors. Using built-in transceivers in the input device(s), each of the input device(s) transceiver can record the beacons' IDs, and determines the received signal strengths, of the beacon transmissions it detects. The received signal strength can establish a maximum plausible distance between the beacon and the input device(s) transceiver. Using the networked application, the transceivers forward some or all of this information to the main content-management server or other processing node (in communication with the application server, e.g., the insurance provider's). The processing node (or main server) can then use this information, together with information about expected received signal strengths in specific areas, to predict the current location (i.e. temporospatial location) of each transceiver ergo each input device(s). Other methods can use triangulation using similar methods but using 3G or 4G (or other) with a plurality (e.g., more than 3) cell towers distributed in the volume. Likewise,

The term “communication path” refers to a communication format that has multiple channels. For example, contemplated communication paths include radio frequency bands, including NOAA frequency band, EAS frequency band, various UHF and/or VHF frequency bands, microwave and infrared frequency bands, frequency bands used for cellular communication, cable and/or satellite TV transmission systems, optical network systems, and/or high-speed digital data transmission systems. The term “channel” can refer to a specific modality within the communication path. For example, where the communication path is cellular communication (e.g., 824-849 MHz, 869-894 MHz, or 1850-1990 MHz), the channel may be a single frequency, or a spectrum of multiple frequencies (e.g., CDMA signal) within that communication path. Likewise, where the communication path is a fiber optic cable system, channels will correspond to high-speed (e.g., >1.0 Mb/s) digital data transmission system, a channel may be a network address.

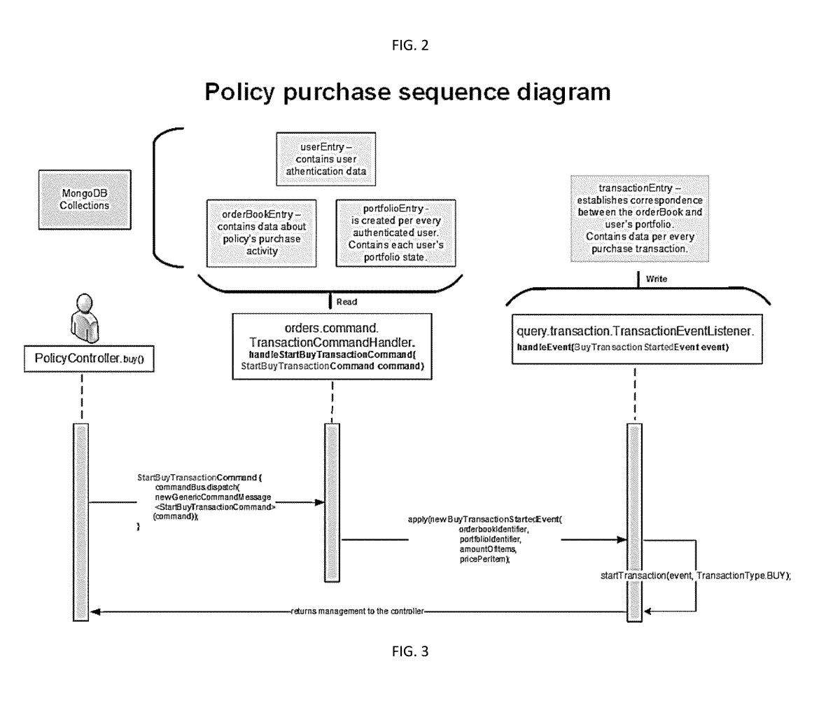

In an embodiment, the system for implementing the methods described herein can further comprise a load balancer in communication with the plurality of wide area network servers, web data servers, node data servers and the like; and the plurality of input device(s). The load balancer can communicate as described herein over a large multi-node network, such as the dedicated WiLAN. The systems described herein, for implementing the methods provided herein, can further comprise an administrative client device and a business client device in communication with the main gateway application server. The term “server” refers for example to the process that provides the service, or the host computer on which the process operates. Similarly, the term “client”, or “client device” refers in another embodiment to the process or device that makes the request, or the host computer/device on which the process operates. As used herein, the terms “client” and “server” can refer to the processes, rather than the host computers, unless otherwise clear from the context. In addition, the process performed by a server can be broken up to run as multiple processes on multiple hosts (sometimes called tiers, see e.g., FIG. 3) for reasons that include reliability, scalability, security and redundancy, among others.

Accordingly, provided herein is a non-transitory computer or processor readable storage medium having stored thereon processor-executable software instructions configured to cause a processor to perform the operations associated with the method for purchasing a product or a service using input device(s) as described herein. These instructions can be, for example, to communicate to the insurance provider the location of the vehicle, or a state of the vehicle, or both; or in another example, electing insurance coverage selected from first party insurance, third party insurance, or a combination thereof, wherein the insurance coverage (for a homeowner) comprises: theft, bodily injury, property damage, flood insurance, or a combination comprising one or more of the foregoing.

In addition, provided herein is a non-transitory computer readable storage medium having stored thereon processor-executable software instructions configured to cause a processor to perform operations associated with the method for generating customized vehicle, temporospatial coverage policy as described herein.

The term “computer-readable medium” as used herein refers to any medium that participates in providing information to the processor, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks. Volatile media include, for example, dynamic memory. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

In an embodiment, provided herein is a method of providing customized residence temporospatial coverage policy to an individual, implementable in the systems described hereinabove comprising: contacting an insurance provider; electing insurance coverage selected from first party insurance, third party insurance, or a combination thereof, wherein the insurance coverage comprises: theft, bodily injury, property damage, flood insurance, or a combination comprising one or more of the foregoing; the insurance provider, based on the individual's predetermined rate factor, issuing a temporospatial insurance coverage policy; and the insurance provider, delivering the insurance coverage policy to the individual.

Also, the methods and systems described herein can be used for providing selectable, temporospatial business insurance. The rating and pricing of business insurance policies can be complex, and may often be made particularly complex by the wide range of different types and classes of businesses. Rating and pricing can be made even more complex by the different geographical, demographic and even environmental conditions that are relevant to the risk of loss for different businesses. For example, certain areas of the U.S. present higher loss risks due to catastrophic conditions such as hurricanes, fires, earthquakes, landslides or floods. As another example, certain areas present higher loss risks due to theft. Current rating and pricing systems do not adequately take territorial and temporal variations into consideration when pricing and evaluating business insurance policies. The systems and methods can therefore provide ad-hoc, temporospatial insurance coverage to a business.

In addition, provided herein is a non-transitory computer readable storage medium having stored thereon processor-executable software instructions configured to cause a processor to perform the operations associated with the method of any of the steps described in the methods described hereinabove.

All ranges disclosed herein are inclusive of the endpoints, and the endpoints are independently combinable with each other. Furthermore, the terms “first,” “second,” and the like, herein do not denote any order, quantity, or importance, but rather are used to denote one element from another. The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the input device(s) includes one or more dislocated device).

Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

The term “plurality”, as used herein, is defined as two or as more than two. The term “another”, as used herein, is defined as at least a second or more. The terms “including” and/or “having”, as used herein, are defined as comprising (i.e., open language).

The term “communication” and its derivatives (e.g., “in communication”) may refer to a shared bus configured to allow communication between two or more devices, or to a point to point communication link configured to allow communication between only two (device) points. Likewise, the term “operatively coupled” or “operably coupled” refers to a connection between devices or portions thereof that enables operation in accordance with the present system. For example, an operative coupling may include one or more of a wired connection and/or a wireless connection between two or more devices that enables a one and/or two-way communication path between the devices or portions thereof. In addition, an operable coupling may include a communication path through a wired and/or wireless network, such as a connection utilizing the Internet. The term contact center is utilized herein to describe a support/service center and as such, may be a contact center, call center, etc.

While particular embodiments have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

1. A method of providing customized vehicle temporospatial coverage policy to an individual, comprising:
a. contacting an insurance provider;
b. electing insurance coverage selected from first party insurance, third party insurance, or a combination thereof, wherein the insurance coverage comprises: collision, bodily injury, property damage, or a combination comprising one or more of the foregoing;
c. the insurance provider, based on the individual's predetermined rate factor, issuing a temporospatial insurance coverage policy; and
d. the insurance provider, delivering the insurance coverage policy to the individual.

2. The method of claim 1, wherein the step of contacting the insurance provider further comprises providing the insurance provider with location of the vehicle, or a state of the vehicle, or both.

3. The method of claim 2, wherein the temporospatial insurance coverage is for a predetermined minimum period.

4. The method of claim 1, wherein the individual's predetermined rate factor comprises; expected trip mileage or kilometerage, trip location, trip beginning point, trip end point, driver's age, driver's record, driver's identity, driver's gender, or a combination comprising one or more of the foregoing.

5. The method of claim 1, wherein the step of issuing a temporospatial insurance coverage policy is preceded by a step of authentication of the user using secured communication between the insurance provider and an application server.

6. The method of claim 1, wherein the vehicle is a marine vehicle, terrestrial vehicle, air vehicle, or a combination thereof.

7. The method of claim 1, further comprising:
a. arriving at a terminal location; and
b. the individual selectively cancelling the first party insurance, third party insurance, or a combination thereof, wherein the insurance coverage comprises: collision, bodily injury, property damage, or a combination comprising one or more of the foregoing.

8. A system for generating customized vehicle temporospatial coverage policy, comprising:
a. an insurance provider server;
b. an application server;
c. an input device within a communication device adapted to contact the insurance provider's server, the application server or both;
d. a processor coupled to the input device comprising a processor readable medium with non-volatile memory having a set of instructions thereon, that executes instructions for electing insurance coverage selected from a first party insurance, a third party insurance, or a combination thereof, wherein the insurance coverage comprises: collision, bodily injury, property damage, or a combination comprising one or more of the foregoing; an output device configured to generate, based on an individual's predetermined rate factor, a temporospatial insurance coverage policy; and
e. a vehicle wherein the temporospatial insurance coverage policy is for a predetermined minimum period.

9. The system of claim 8, wherein the input device is configured to communicate to the insurance provider the location of the vehicle, or a state of the vehicle, or both.

10. The system of claim 9, wherein the insurance provider server further comprise processor with memory having thereon a computer-readable media with executable instructions for determining the individual's rate factor.

11. The system of claim 10, wherein the individual's predetermined rate factor comprises; expected trip mileage or kilometerage, trip location, trip beginning point, trip end point, driver's age, driver's record, driver's identity, driver's gender, or a combination comprising one or more of the foregoing.

12. The system of claim 11, wherein the application server is in secured communication with the insurance provider's server.

13. The system of claim 12, wherein the processor of the input device further executes instructions contained in memory for, once arriving at a terminal location; selectively cancelling the first party insurance, third party insurance, or a combination thereof, wherein the insurance coverage comprises: collision, bodily injury, property damage, or a combination comprising one or more of the foregoing.

14. A method of providing customized residence temporospatial coverage policy or business temporospatial insurance, or both to an individual or a business or both, comprising:
a. contacting an insurance provider;
b. electing insurance coverage selected from first party insurance, third party insurance, or a combination thereof, wherein the insurance coverage comprises: theft, bodily injury, property damage, flood insurance, or a combination comprising one or more of the foregoing;
c. the insurance provider, based on the individual's or business or both predetermined rate factor, issuing a temporospatial insurance coverage policy; and
d. the insurance provider, delivering the insurance coverage policy to the individual.

15. The method of claim 14, wherein property damage is provided on a permanent basis when the residence is purchased with burrowed funds, and is configured to be the amount borrowed.

16. The method of claim 15, wherein the temporospatial insurance coverage is for a predetermined minimum period.

17. The method of claim 16, wherein the individual's predetermined rate factor comprises; residence location, residence age, the individual's current or expected income level, geographical region, or a combination comprising one or more of the foregoing.

18. The method of claim 17, wherein the step of issuing a temporospatial insurance coverage policy is preceded by a step of authentication of the user using secured communication between the insurance provider and an application server.

19. The method of claim 14, further comprising the individual selectively cancelling the first party insurance, third party insurance, or a combination thereof, wherein the insurance coverage comprises: theft, bodily injury, property damage, flood insurance, or a combination comprising one or more of the foregoing.

20. A system for providing customized residence temporospatial coverage policy to an individual, comprising:
a. an insurance provider server;
b. an application server;
c. an input device within a communication device adapted to contact the insurance provider's server, the application server or both;
d. a processor coupled to the input device that executes instructions contained in a non-volatile memory for electing insurance coverage selected from first party insurance, third party insurance, or a combination thereof, wherein the insurance coverage comprises: theft, bodily injury, property damage, flood insurance, or a combination comprising one or more of the foregoing;
e. an output device configured to generate, based on an individual's predetermined rate factor, a temporospatial residence insurance coverage policy; and
f. a residence, wherein the temporospatial insurance coverage policy is for a predetermined minimum period to all coverage other than property damage provided on a permanent basis when the residence is purchased with burrowed funds, and is configured to be the amount borrowed.
